(19) United States
(12) Patent Application Publication
(10) Pub. No.: US 2010/0215465 A1
(43) Pub. Date: Aug. 26, 2010

(54) Vehicle carrier assembly

(76) Inventor: Carl Lewis, San Diego, CA (US)

Correspondence Address: LAW OFFICES OF ANDREW SCHROEDER, P.O. Box 6731, Santa Maria, CA, 93454, US

(21) Appl. No.: 12/380,235

(22) Filed: Feb. 25, 2009

(51) Int. Cl. B60P 1/44; B60D 1/00

(52) U.S. Cl. 414/477; 414/563

(57) ABSTRACT

An improved vehicle carrier assembly for use with carrier vehicles to secure four wheels of a vehicle to be transported includes at least two beams, at least four wheel carriers, and a drive assembly. The two beams are comprised of a first beam and a second beam. The first beam is substantially parallel with the second beam, both the first beam and the second beam comprise an inboard side and an outboard side. The inboard side comprises an elevated shim for the purpose of enabling one wheel carrier to cross-over the other wheel carrier for the purpose of engaging all four wheels of a vehicle to be transported. The wheel carriers are in communication with the drive assembly. The drive assembly is comprised of a motor.

### CROSS-REFERENCE TO ALLOWED PATENTS

The present invention is an improvement upon U.S. Pat. No. 6,290,449 entitled “Vehicle Carrier”.

### FIELD OF THE INVENTION

This invention is related with transportation vehicles and pertains more specifically to systems used for the purpose of facilitating the transportation of various vehicles by tow trucks.

### BACKGROUND OF THE INVENTION

Modern day tow trucks are designed for ease of operation, safety and to prevention of damage to the vehicle being towed. Some of these modern tow trucks include the following:

In U.S. Pat. No. 5,607,279 Inventor Richard W Hill teaches a boom accessory for a flat bed tow truck that includes a frame that is lockable onto a power underlift hoist of a truck by retraction of a ram of the hoist against the truck frame. The frame includes a base for engagement on the ram, an upwardly and rearwardly extending boom member, and optionally, a rearward facing trailer hitch socket for permitting trailers to be towed with the boom accessory in place. A sleeve assembly is pivotally mountable atop the boom member for engaging a hook cable extending from a winch unit of the truck, the accessory extending the utility of the tow truck by enabling retrieval of disabled vehicles without significant modification of the truck. A method for hoisting a load by the flatbed tow truck includes the steps of providing the boom accessory, extending the ram, resting the base on the ram, retracting the ram for clamping the base between the head portion of the ram and the leg member, threading the cable over the sheave, connecting the cable to the load and activating the winch for moving and hoisting the load, the cable being movably supported by the sheave. All of the past and present tow trucks require that considerable manual labor to prepare the disabled vehicle for towing.

In U.S. Pat. No. 5,607,279 Inventor Richard W Hill teaches a boom accessory for a flat bed tow truck that includes a frame that is lockable onto a power underlift hoist of a truck by retraction of a ram of the hoist against the truck frame. The frame includes a base for engagement on the ram, an upwardly and rearwardly extending boom member, and optionally, a rearward facing trailer hitch socket for permitting trailers to be towed with the boom accessory in place. A sleeve assembly is pivotally mountable atop the boom member for engaging a hook cable extending from a winch unit of the truck, the accessory extending the utility of the tow truck by enabling retrieval of disabled vehicles without significant modification of the truck. A method for hoisting a load by the flatbed tow truck includes the steps of providing the boom accessory, extending the ram, resting the base on the ram, retracting the ram for clamping the base between the head portion of the ram and the leg member, threading the cable over the sheave, connecting the cable to the load and activating the winch for moving and hoisting the load, the cable being movably supported by the sheave. The use of this device is very labor intensive.

U.S. Pat. Nos. 4,797,057; 4,678,392 and 5,662,453 teach additional versions of wheel lifts for a tow truck. These patents like Hill above require considerable manual labor from the tow truck operator for their manipulation.

U.S. Pat. Nos. 5,662,453; 5,133,633 and 4,929,142 teach various renditions of vehicle carrier assemblies with tilt beds that tilt downward in the rear of the carrier to the same elevation as the vehicle to be transported and the vehicle a cable is attached by the vehicle carrier assembly operator and the vehicle to be transported is pulled upon the tilted bed.

U.S. Pat. No. 6,290,449, the patent upon which this improvement is predicated, was designed to augment the translation of a vehicle to be towed up onto the bed of a tow truck. The I-beam assembly in this particular invention included only one I beam.

### SUMMARY OF THE INVENTION

The vehicle carrier assembly of the present invention employs an articulating I beam assembly centered on the rear of a truck type carrier. Whereas U.S. Pat. No. 6,290,449 included only one I beam, the present invention seeks to augment the stability of the previous patent by adding at least one more I-beam. By augmenting the stability of the previous invention, more stability is accrued. By adding more stability to the vehicle carrier assembly, more strength can be gained with lighter materials improving payload in contrast to the single I-beam assembly of U.S. Pat. No. 6,290,449. Moreover, by using lighter materials, a tow truck may be able to gain more payload.

Moreover, one of the principle mechanisms which enable the present invention is the ability of the lifting mechanisms to be able to pass over each other. By allowing for one wheel carrier to cross over the other, all four wheels of a vehicle can be secured and engaged.

Through the engagement of all four wheels of a vehicle, the operating tow truck becomes a “hybrid” tow truck. This hybrid tow truck incorporates the best features of two types of tow trucks: the flat bed tow truck and the pulling tow truck. With the flat bed tow truck, the entire vehicle is mounted onto a flat bed whereas in the pulling tow truck, the two front tires of a towed vehicle are lifted off the ground and the rear wheels are left on the road. With the hybrid tow truck which is enabled with the present invention, all four wheels are secured and engaged and are secured upon a flat bed. This hybrid tow truck is safer and easier to use as opposed to the aforementioned tow trucks.

This is the only truck of its kind that can fully load a vehicle on to the truck without having the operator physically touching the car to be loaded. In fact, the operator can load a car without getting out of the truck.

### BRIEF DESCRIPTION OF THE DRAWING FIGURES

FIG. 1a illustrates a side view of a preferred embodiment of the present invention.

FIG. 1b illustrates a side view of a preferred embodiment of the present invention.

FIG. 1c illustrates a side view of a preferred embodiment of the present invention.

FIG. 1d illustrates a plan view of a preferred embodiment of the present invention.

FIG. 1e illustrates a side view of a preferred embodiment of the present invention.

FIG. 2 illustrates a side view of a preferred embodiment of the present invention.

FIG. 3a is a cross-sectional showing of a preferred embodiment of the present invention.

FIG. 3b is a cross-sectional showing of a preferred embodiment of the present invention.

FIG. 3c is a cross-sectional showing of a preferred embodiment of the present invention.

FIG. 4 illustrates a preferred embodiment of the present invention.

FIG. 5 is a plan view of a preferred embodiment of the present invention.

FIG. 6 illustrates a plan view of a preferred embodiment of the present invention.

FIG. 7 illustrates a side view of a preferred embodiment of the present invention.

### DESCRIPTION OF PREFERRED EMBODIMENTS

According to a preferred embodiment of the present invention, a unique system, and apparatus is used in conjunction with tow trucks and similar vehicles for the purpose of hauling various vehicles. Typically, these vehicles have a bed or similar apparatus from which a vehicle is supported in a substantially flat orientation parallel with the ground. The present invention is described in enabling detail below.

The present invention is an improvement upon U.S. Pat. No. 6,290,449 (hereafter '449) and hereby incorporates the features taught therein. The main improvement upon US Patent '449 is the addition of at least one more I-beam to the articulating I beam assembly. By incorporating a plurality of I-beams, the entire apparatus gains increased stability. By increasing the stability of the apparatus, lighter and less expensive materials may be substituted for the stronger, heavier, and more expensive materials required by US Patent '449.

For the purposes of the present invention the term “translate” shall mean the process of moving, pulling, or other methods of moving a vehicle up or down the vehicle carrier assembly.

For the purposes of the present invention the term “tow vehicle” shall include all vehicles expedient for the purpose of carrying other vehicles on a substantially flat bed or transport frame.

For the purposes of the present invention, the term “I-beam” shall refer to the elongate member disposed along the length of the tow vehicle for the purpose of supporting the vehicle to be towed along with the rest of the assemblies. The present invention incorporates at least two I-beams which are disposed side by side from each other.

For the purposes of the present invention the term “articulate” or “articulating” shall mean or be synonymous with tilting, rotating, or otherwise raising or lowering the vehicle carrier assembly. This movement lifts the vehicle carrier assembly up and down.

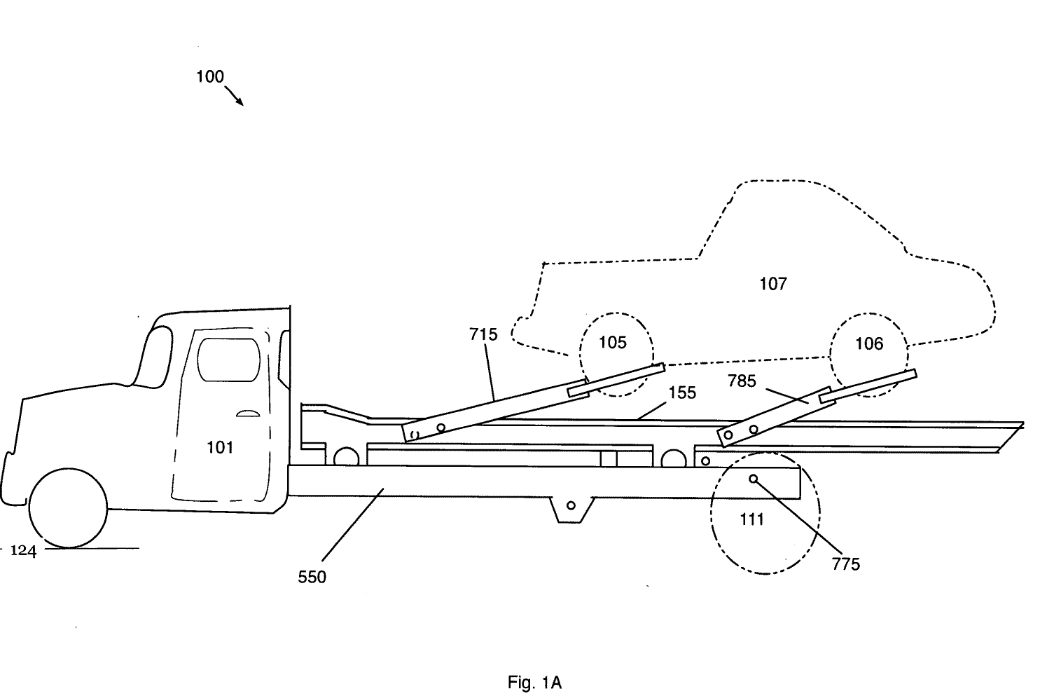

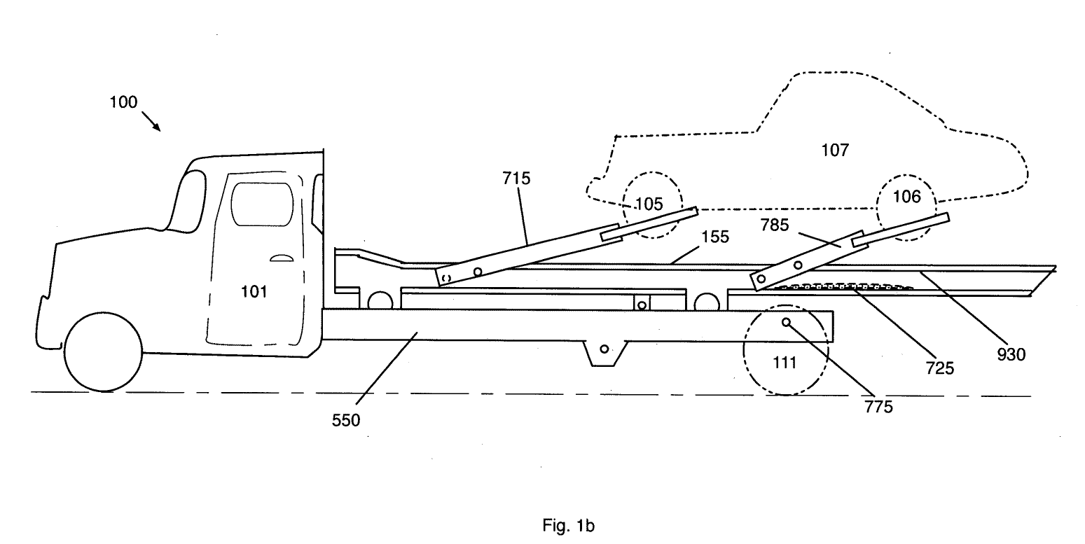

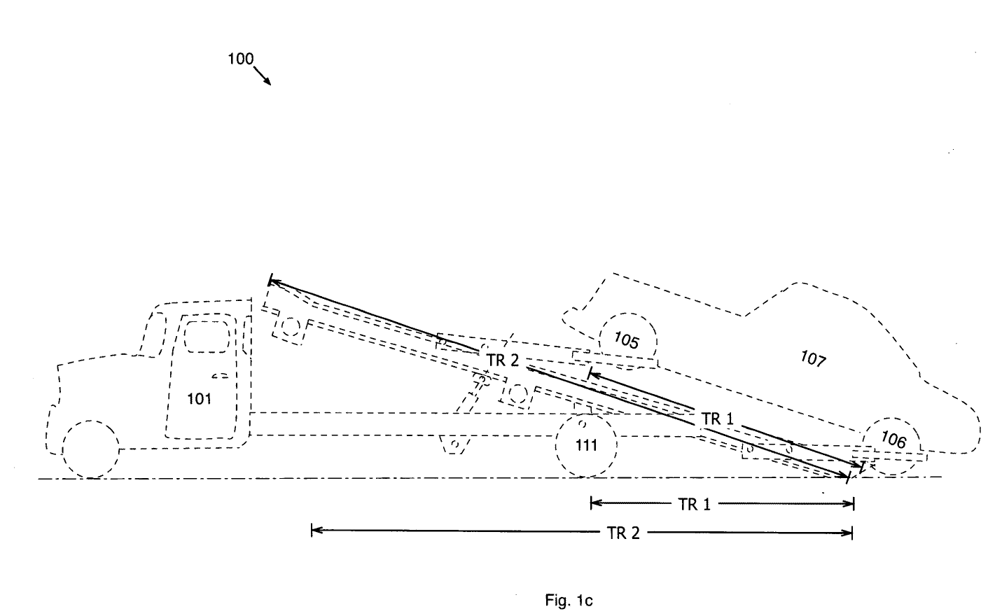

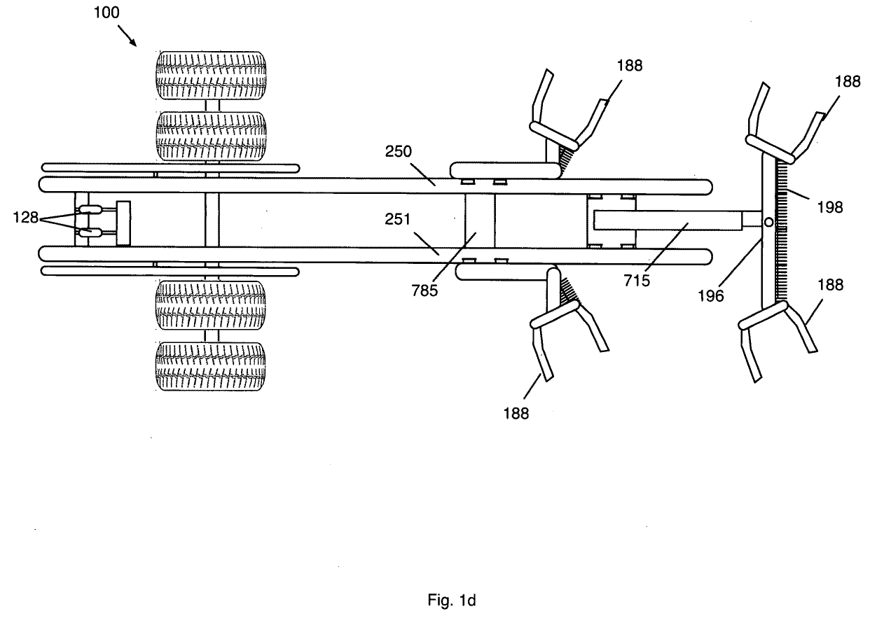

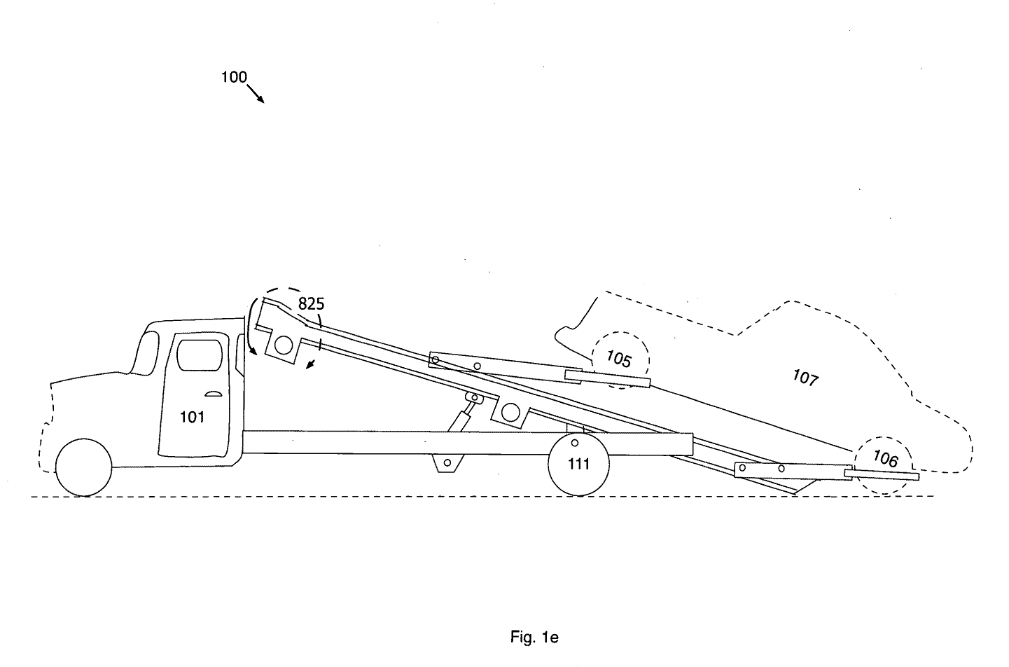

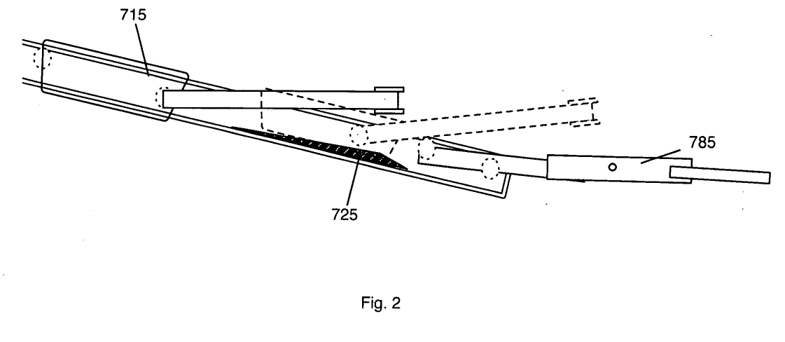

FIGS. 1a-1e illustrate a preferred embodiment of the present invention. The vehicle carrier assembly 100 is mounted upon a vehicle 101 typically used to tow, haul, or otherwise move various vehicles. The vehicle 101 has support wheels 111 resting on a surface 124.

It should be noted here that the present invention does not necessarily encompass the towing vehicle 101 itself in all embodiments. Some embodiments encompass only the I-beam assembly, actuators, wheel carriers, and drive assembly. Other embodiments may further include the vehicle 101 as well.

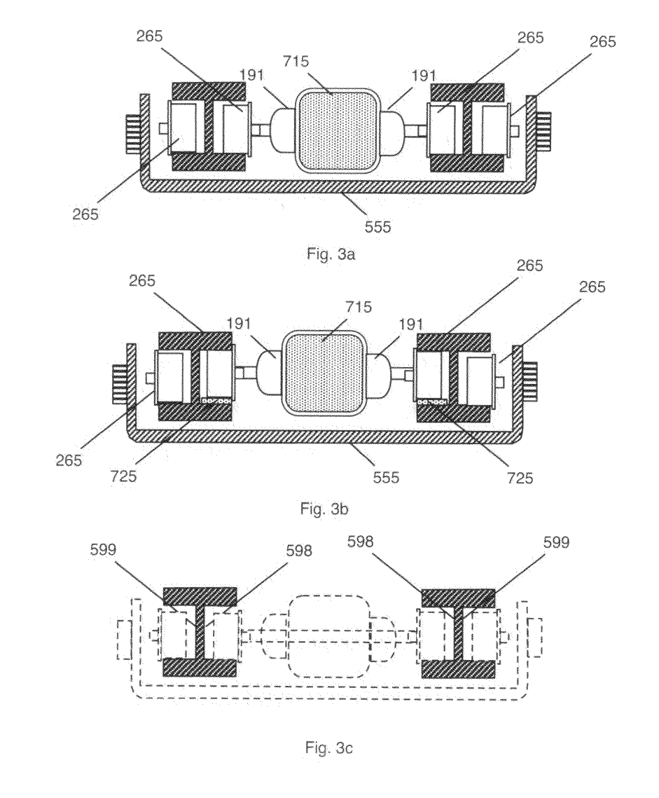

The vehicle carrier assembly 100 is pivotally attached to the frame 550 of the tow vehicle 101 at pivot point 775 (see drawing FIG. 1A). The vehicle carrier assembly 100 is comprised of at least two beams. The first beam 250 is substantially parallel with the second beam 251 as illustrated in FIG. 1d. FIGS. 3a-3c illustrate that both the first beam 250 and the second beam 251 have an Inboard Side 598 and an Outboard side 599. In some preferred embodiments, the Inboard Side 598 of the first beam 250 and second beam 251 further incorporate an Elevated Shim 725 as illustrated in FIGS. 1b and 3b. It should be noted here that the tow vehicle 101 may incorporate more beams in other preferred embodiments. At least one actuator(s) 128 powers the tilt of the vehicle carrier assembly 100 between a stowed position and a full tilt vehicle load position as illustrated in FIG. 1d.

In some preferred embodiments the actuator(s) 128 may be a conventional hydraulic pump of the sort well known in this art. In some preferred embodiments the actuator(s) 128 may be operated from the cab portion of the tow vehicle 101. The actuator(s) 128 provides controlled hydraulic pressure to or bleeds hydraulic pressure from the actuator 128. In other preferred embodiments the actuator(s) 128 may be an electric motor.

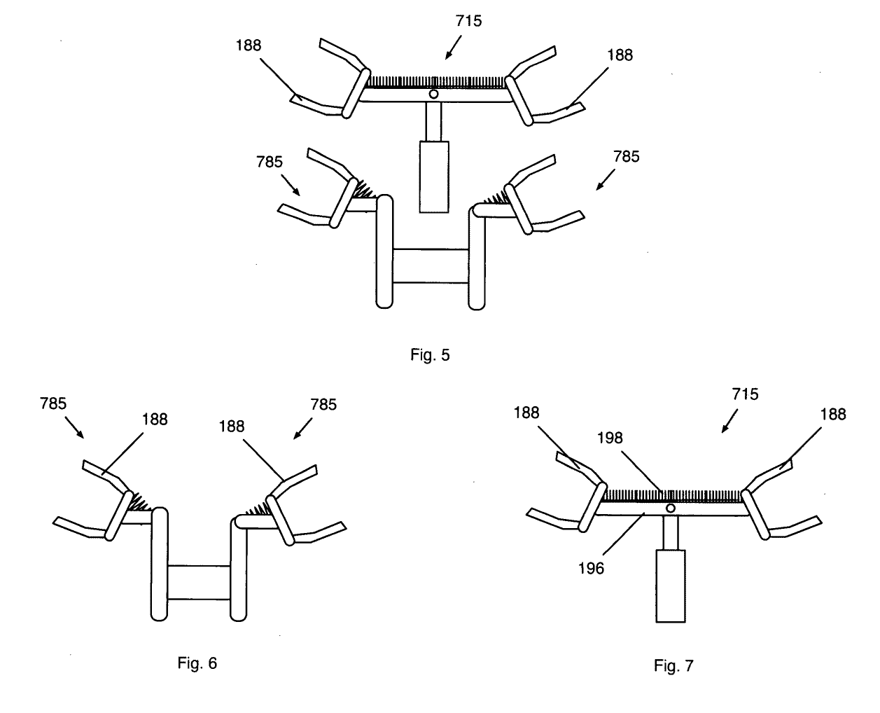

FIGS. 5-7 illustrate that in some preferred embodiments the vehicle carrier assembly 100 includes at least one pair of wheel carriers 715 and 785. The wheel carriers 715, 785 are translatable along the vehicle carrier assembly 100 from a stowed position as shown in FIG. 1e to various deployed positions.

FIG. 1C illustrates the travel range (TR) of each wheel carrier 715 and 785. Wheel Carrier 785 has a TR illustrated as TR 1 and engages the rear wheels of the vehicle 107 to be towed. Wheel carrier 715 has a TR depicted as TR 2 and engages the front wheels of the vehicle 107 to be towed. The TR of wheel carrier 715 is made possible, in part, through a Shim 199. This elevated Shim 725 enables wheel carrier 715 to pass over the other Wheel Carrier 785. This cross-over mechanism is distinguished over the prior art by enabling a tow truck operator to engage all four wheels of a vehicle.

In some preferred embodiments the wheel carriers 715 and 785, are translated through the use of rollers 265. The rollers 265 are in communication with spacers 191 as illustrated in FIGS. 3a-3c. The wheel carriers 715 and 785 ride along the top 155 of the vehicle carrier assembly 100 while rollers 265 rides along the bottom of the upper surface 930 of the vehicle carrier assembly 100 as illustrated in FIG. 1b.

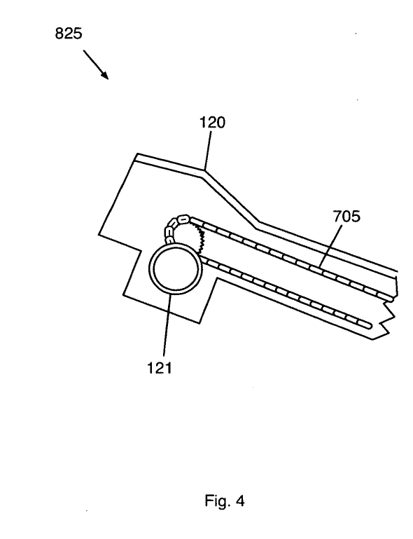

The wheel carriers 715 and 785 are translated along the vehicle carrier assembly 100 by the drive assembly 825 as illustrated in FIG. 4. In some preferred embodiments the drive assembly 825 is comprised of a motor 121 and chains 705. The chains 705 are engaged with the motor 121 for the purpose of translating the wheel carriers 715 and 785 along the vehicle carrier assembly 100. In some preferred embodiments the motor 121 may be a simple electric motor. In other preferred embodiments the motor 121 may be hydraulic. In some preferred embodiments there may be two drive assemblies 825, one on each of the I-beams 250, 251. The chain 705 is attached to one of the wheel carriers 715 and 785 and the wheel carrier is translated in a direction determined by the rotational direction of the motor 121. A similar drive assembly 825 on the opposite side of the vehicle carrier assembly 100 drives one of the wheel carriers 715 and 785 as the one shown which is identical drives the other wheel carriers 715 and 785.

FIG. 7 illustrates that in some preferred embodiments wheel carriers 715 and 785 includes a cross arm 196. On each distal end of the cross arm 196, is a pivotal “U” shaped wheel, capturing member 188 (hereafter “U-member). Between each of the “U” members 188 is a bias spring 198, that pivots the “U” members toward each.

Referring now specifically to drawing FIG. 1e, this Figure depicts a vehicle 107 to be transported by the vehicle carrier assembly 100. The vehicle 107 is shown with its front wheels in the wheel carriers 715 and 785 in a position to translate the wheel carriers 715 and 785 around rear wheels. In operation, the vehicle carrier assembly 100 is tilted to allow the wheel carrier to translate rear-wardly to engage wheels. The wheel carrier is then translated along the vehicle carrier assembly 100 until the rear wheels are in position for translation of the wheel carrier rear-wardly to capture the wheels and then both wheel carriers 715 and 785 are simultaneously translated along the vehicle carrier assembly 100 and the vehicle carrier assembly 100 is pivoted toward the vehicle carrier assembly frame 550 to a position substantially horizontal to the carrier vehicle frame 550.

The inclination of wheel carrier changes to a smaller angle relative to the vehicle carrier assembly 100 as it is translates over the curved surface 120 at the proximal end of the vehicle carrier assembly 100 toward the cab 101. This feature improves the clearance between wheel carriers and lowers the height of the front of the carried vehicle when moved proximally from the position shown in the drawing FIG. 1 position.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. An improved vehicle carrier assembly for use with carrier vehicles to secure four wheels of a vehicle to be transported comprises:
at least two beams, at least four wheel carriers, and a drive assembly;
the two beams are comprised of a first beam and a second beam;
the first beam is substantially parallel with the second beam;
both the first beam and the second beam comprise an inboard side and an outboard side;
the inboard side comprises an elevated shim for the purpose of enabling one wheel carrier to cross-over the other wheel carrier for the purpose of engaging all four wheels of a vehicle to be transported;
the wheel carriers are in communication with the drive assembly;
the drive assembly is comprised of a motor.

2. The improved vehicle carrier assembly for use with carrier vehicles to secure four wheels of a vehicle to be transported of claim 1 wherein the vehicle carrier assembly comprises a hydraulic motor.

3. The improved vehicle carrier assembly for use with carrier vehicles to secure four wheels of a vehicle to be transported of claim 1 wherein the wheel carriers further comprise a U-member.

4. The improved vehicle carrier assembly for use with carrier vehicles to secure four wheels of a vehicle to be transported of claim 1 wherein the drive assembly further comprises chains which are in communication with the motor and are engaged with the wheel carriers for the purpose of translating the wheel carriers along the vehicle carrier assembly.

5. A Hybrid Towing Vehicle comprises:
at least two beams, at least four wheel carriers, and a drive assembly;
the two beams are comprised of a first beam and a second beam;
the first beam is substantially parallel with the second beam;
both the first beam and the second beam comprise an inboard side and an outboard side;
the inboard side comprises an elevated shim for the purpose of enabling one wheel carrier to cross-over the other wheel carrier for the purpose of engaging all four wheels of a vehicle to be transported;
the wheel carriers are in communication with the drive assembly;
the drive assembly is comprised of a motor.

6. The Hybrid Towing Vehicle of claim 5 further comprises a flat bed frame upon which a towed vehicle may rest.

7. The Hybrid Towing Vehicle of claim 5 wherein the vehicle carrier assembly comprises a hydraulic motor.

8. The Hybrid Towing Vehicle of claim 5 wherein the wheel carriers further comprise a U-member.

9. The Hybrid Towing Vehicle of claim 5 wherein the drive assembly further comprises chains which are in communication with the motor and are engaged with the wheel carriers for the purpose of translating the wheel carriers along the vehicle carrier assembly.

10. The Hybrid Towing Vehicle of claim 5 further comprises a hydraulic motor.
